(19) United States
(12) Patent Application Publication
(10) Pub. No.: US 2011/0017842 A1
(43) Pub. Date: Jan. 27, 2011

(54) Rotary Irrigation Sprinkler With A Turret Mounted Drive System

(76) Inventors: Derek Michael Nations, Tucson, AZ (US); Michael Albert McAfee, Tucson, AZ (US); Jorge Alfredo Duenas Lebron, Nogales (MX); Kenneth John Skripkar, Tucson, AZ (US); Steve Craig Haeske, Allendale, MI (US)

Correspondence Address: FITCH EVEN TABIN & FLANNERY, 120 SOUTH LASALLE STREET, SUITE 1600, CHICAGO, IL, 60603-3406, US

(21) Appl. No.: 12/828,059

(22) Filed: Jun. 30, 2010

Related U.S. Application Data
(60) Provisional application No. 61/222,415, filed on Jul. 1, 2009.

(51) Int. Cl. B05B 3/06

(52) U.S. Cl. 239/251

(57) ABSTRACT

Disclosed are rotary sprinklers having a turret mounted drive system. In one aspect, the complete drive mechanism, including all components thereof, is positioned in the rotary turret portion of the rotary sprinkler. In another aspect, the turret mounted drive system includes a main drive element, such as a turbine, paddle wheel, or the like, positioned adjacent a flow passage or nozzle outlet and oriented to be driven from a fluid flow projected from the sprinkler. In yet another aspect, the turret mounted drive system also has associated gearing assemblies, which may include appropriate gear reduction modules, also mounted within the turret, but outside of the fluid flow path.

### CROSS-REFERENCE TO RELATED APPLICATIONS

This application claims benefit of U.S. Provisional Application No. 61/222,415, filed Jul. 1, 2009, which is hereby incorporated herein by reference in its entirety.

### FIELD

The field relates to irrigation sprinklers and, more particularly, to rotary irrigation sprinklers.

### BACKGROUND

A rotary irrigation sprinkler commonly includes a rotatable turret mounted at an upper end of a lower stationary body or other fixed assembly. The turret includes one or more nozzles for discharging water and is commonly rotated in a full circle or back and forth part circle motion to provide irrigation over a ground surface area. Rotary sprinklers generally include a drive mechanism, such as a water-driven motor, to transfer energy of the incoming water into a source of power to rotate the turret. One common mechanism for the motor employs a water-driven turbine and a gear train or gear reduction system to convert a high-speed rotation of the water-driven turbine into relatively low-speed turret rotation. During normal operation, the flow of incoming water into the sprinkler rotates the turbine at a relatively high rotational speed due to the velocity and pressure of the supply water. Then, the gear reduction system converts the relatively high rotational speed of the turbine to a lower rotational speed used to rotate the turret. The turret then rotates to distribute water outwardly from the sprinkler over surrounding terrain in an arcuate pattern.

The most convenient placement for these water-driven motors is usually in the lower stationary body of the sprinkler assembly, which is upstream of the turret and nozzle and in the water flow path. The stationary body of the sprinkler generally provides the most space to receive the motor and other components of the drive assembly, as the inside of this stationary body is relatively large enough to house both the turbine and other gear reduction components. In this position, however, the entire drive motor and gear train is within the water flow path and, therefore, potentially exposed to any dirt or debris in the water, which may work its way into the individual gearing components. Dirt lodged in the gear train and reduction system can damage and limit the useful life of the gearing mechanisms.

If the turbine or gearing becomes damaged, due to the location of the water-driven motor in the stationary body and upstream of the turret, these units are generally not easily accessed in an installed sprinkler system to perform field repairs. Typically, if a gear train becomes damaged, the entire sprinkler assembly including both the turret and lower stationary body may need to be replaced because the motor generally cannot be accessed in the sprinkler body as a result of the turret components hindering access.

The location of the drive motor upstream of the rotary turret in the stationary body and within the water flow path also may require higher starting pressures to compensate for a pressure drop across the motor. Because the entire water-driven motor and the gear train assembly are in the water flow path, and therefore constrict the flow path, the flow past the motor typically experiences an undesired pressure drop. In some cases, the pressure drop across a common turbine and gear train system is upwards of about 10 psi, which is usually experienced by the entire water stream due to the location of the drive motor upstream of the nozzles. Pressure drops in fluid are undesired in sprinkler systems because a loss of pressure results in a decrease in throw distance from the sprinkler nozzle. Thus, higher pressures upstream of the sprinkler are often required to compensate for the loss of pressure across the motor unit. Higher fluid pressures can require a larger and generally more costly pumping system.

### BRIEF DESCRIPTION OF THE DRAWINGS

FIG. 1 is a perspective view of an exemplary rotary sprinkler;

FIG. 2 is a partial cross-sectional view of a turret mounted drive system;

FIG. 3 is a front view of the turret mounted drive system of FIG. 2;

FIG. 4 is a top view of the turret mounted drive system of FIG. 2;

FIG. 5 is a partially exploded side view of the turret mounted drive system of FIG. 2;

FIG. 6 is another partially exploded side view of the turret mounted drive system of FIG. 2;

FIG. 7 is a partial cross-sectional view of another form of a turret mounted drive system;

FIG. 8 is a top view of the turret mounted drive system of FIG. 7;

FIG. 9 is a perspective view of another turret mounted drive system;

FIG. 10 is a partial cross-sectional view of the turret mounted drive system of FIG. 9;

FIG. 11 is a perspective view of another turret mounted drive system;

FIG. 12 is another perspective view of the turret mounted drive system of FIG. 11;

FIG. 13 is a perspective view of another form of a turret mounted drive system;

FIG. 14 is cross-sectional view of the turret mounted drive system of FIG. 13;

FIG. 15 is a perspective view of an exemplary turret cartridge used with the turret mounted drive system of FIG. 13;

FIG. 16 is another cross-sectional view of the turret mounted drive system of FIG. 13;

FIG. 17 is a perspective view of the turret mounted drive system of FIG. 13 with the cartridge removed for clarity;

FIG. 18 is a perspective view of an exemplary reversing mechanism used with the turret drive system of FIG. 13;

FIG. 19 is a partially exploded view of the turret mounted drive system of FIG. 13 showing the components of the exemplary reversing mechanism;

FIG. 20 is another partially exploded view of the turret mounted drive system of FIG. 13 showing the components of the reversing mechanism;

FIG. 21 is a partial cross-sectional view of the turret mounted drive system of FIG. 13 showing the reversing mechanism; and

FIG. 22 is another partial cross-sectional view of the turret mounted drive system of FIG. 13 showing the reversing mechanism with some components removed for clarity.

### DETAILED DESCRIPTION OF THE PREFERRED EMBODIMENTS

Disclosed are rotary sprinklers having a compact turret mounted drive system. In one aspect, the complete drive mechanism, including all components thereof, are positioned entirely at a housing forming the rotary turret portion of the rotary sprinkler. The drive systems, as a whole unit, rotate along with the turret portion of the sprinkler. This configuration is in contrast to prior rotary sprinklers where such drive components are positioned upstream in the non-rotary body portion and did not rotate or turn as a whole unit.

In another aspect, the compact turret mounted drive systems include a main drive element, such as a turbine, paddle wheel, or the like, positioned adjacent an outlet flow channel or nozzle outlet of the sprinkler at either an upstream or downstream end portion thereof in the rotating nozzle turret and oriented to be driven from at least a portion of a fluid flow that is ultimately discharged from the sprinkler. In one approach, the main flow of fluid is portioned in the turret so that one portion of fluid is directed to one or more nozzles and bypasses the drive mechanism, and a second portion of fluid is separated from the main flow and directed to engage the main drive element proximate to the outlet flow channel or nozzle to drive the rotary turret. In some approaches, this flow may have its energy reduced by contact with the main drive element and then projected from the sprinkler as a close-in watering stream.

In yet another aspect, the compact turret mounted drive systems also may have its associated gearing assembly, which may include an appropriate gear reduction module, mounted within the same rotating turret housing, but outside of the fluid flow path. Therefore, in contrast to prior rotary sprinklers where the entire drive unit may be exposed to flowing water, only the main drive element of the drive system is exposed to the flowing fluid.

By positioning the main drive element adjacent to and, in some cases, at the downstream end of the sprinkler nozzle and/or outlet flow passage of the rotating turret, a portion of the fluid flow exiting the sprinkler impacts the main drive element and not only provides energy to rotate the turret but, at the same time, also uses the main drive element to reduce the stream energy of at least a portion of the flow to form a reduced-energy, close-in watering stream or spray. Thus, the compact turret mounted drive systems advantageously use the pressure drop across the drive unit and, in particular, the main drive element thereof to form a close-in watering flow. Therefore, fewer or no additional obstructions, pressure drop chambers, or other tortuous flow paths are preferably needed to reduce stream energy for close-in watering, as such flow energy reduction is achieved via the drive motor.

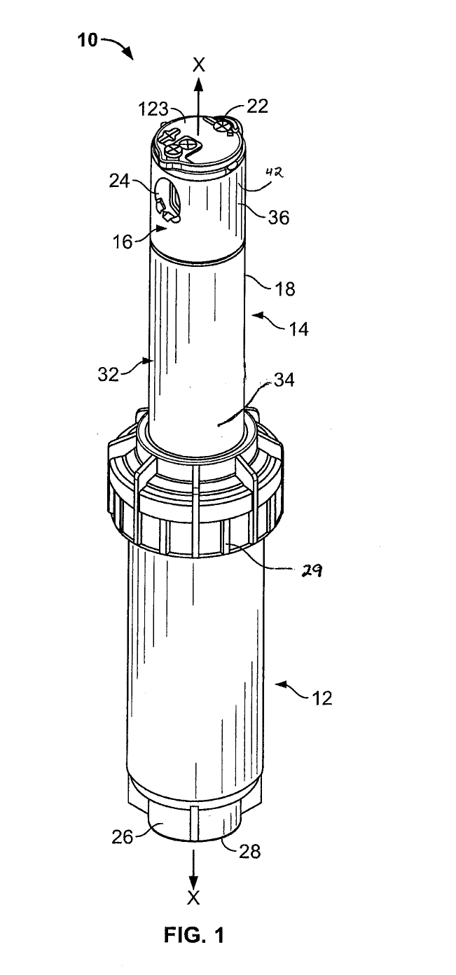

By one approach, the drive mechanisms provided herein are suitable for a rotary pop-up sprinkler, but also may be used on other rotary-type sprinklers. For convenience, the drive mechanisms will be described with an exemplary pop-up type sprinkler. As shown in FIG. 1, for example, a suitable rotary pop-up sprinkler 10 is shown that includes a stationary sprinkler housing 12 for being received in the ground. The housing 12 has a longitudinal axis “X” extending between opposite ends thereof and a pop-up riser assembly or riser tube 14 configured to shift axially along the housing axis X. The riser assembly 14 includes a rotatable nozzle turret 16 on an upper end 18.

In general, the sprinkler housing 12 provides a protective covering for the riser assembly 14 and serves as a conduit for directing incoming water under pressure to the riser. The housing 12 preferably has the general shape of a cylindrical tube and may be made of a sturdy lightweight injection molded plastic or similar material. The housing 12 has a lower end 26 with an inlet 28 that may be coupled to a water supply pipe or other source of fluid. At the opposite end, the housing 12 may also include an upper cap 29 having an aperture therein in which the riser assembly 14 slideably extends through.

The riser assembly 14 is in fluid communication with the fluid received by the housing 12 and is configured to travel along the axis X between a spring-retracted position, where the riser 14 is retracted into the housing 12, and an elevated spraying position, where the riser 14 is elevated out of the housing 12, as generally shown in FIG. 1. The riser assembly 14 includes the rotatable nozzle turret 16 and a lower, non-rotatable or stationary body portion 32. The turret 16 has at least one opening 24 in an outer wall thereof that includes at least one or more nozzles, flow passages, or outlet flow channels therein for distributing water over an adjacent ground surface area. When the supply water is on, the riser assembly 14 extends out of the housing 12 and above ground level so that water can be distributed from the nozzle over the ground surface area for irrigation. When the water is shut off at the end of a watering cycle, the riser assembly 14 retracts into the housing 12 where it is protected from damage.

The stationary body 32 has a lower end 34 and the upper end 18. The rotatable turret 16 is rotatably mounted on the upper end 18. The rotatable turret 16 includes a housing 36 forming the main structure of the turret 16 that rotates relative to the stem 32 to discharge water over a predetermined pattern, which may be adjustable from part-circle, reversing rotation between 0° to 360° arcuate sweeps or a full-circle, non-reversing rotation. The non-rotatable riser stem 32 may be an elongated hollow tube, which is preferably made of a lightweight molded plastic or similar material or stainless steel.

Prior drive mechanisms positioned a turbine and gear train assembly upstream of the nozzle and turret in the riser stem 32 so that both the turbine and gear train assembly were located in the water flow path. As described in more detail below, the drive mechanisms provided herein are located internally to the housing 36 of the turret 16 and only position a main drive element, such as a turbine, paddle wheel, drive element and the like, in the water flow path with the remaining associated gear train components isolated from the water flow path, but still contained in the turret housing 36. Therefore, the drive components are easily accessible in the turret 16, which is located on the upper end of the riser assembly 14, and if needed, the turret 16 can easily be replaced or repaired in some instances rather than needing to replace the entire riser assembly.

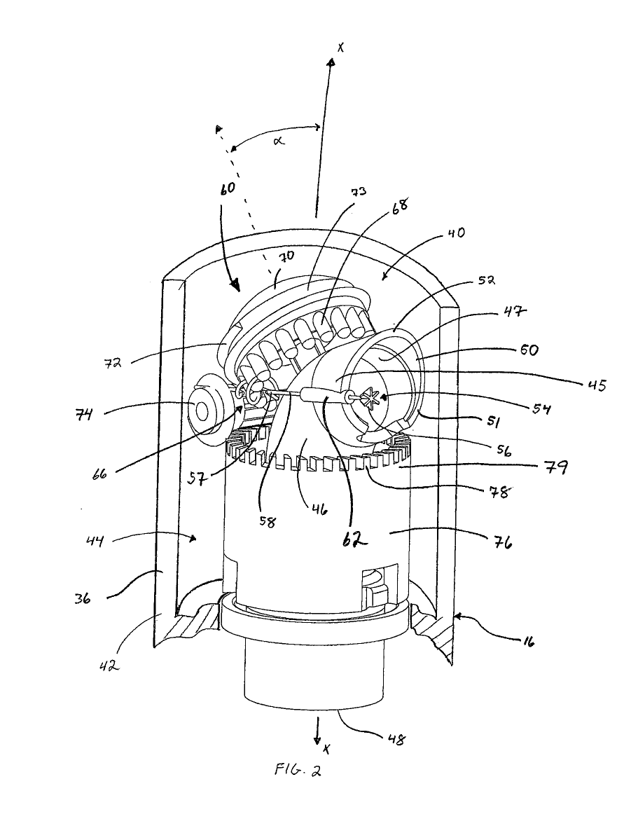

Turning FIGS. 2-4, one form of a compact, turret mounted drive system 40 is provided. The turret housing 36 has a generally tubular configuration formed by an annular side wall 42, but other shapes and configuration also may be used. The annular side wall 42 forms an internal cavity 44, which is completely surrounded by the wall 42, sized to receive all components of the drive system 40 and all aspects of the sprinkler's flow assembly.

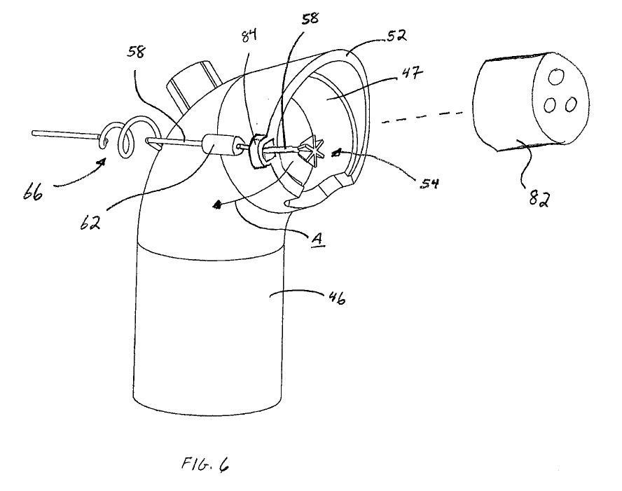

The turret housing 36 includes an internal flow channel 46 that directs fluid from an inlet 48 at a lower end, in fluid communication with the body 32, to an outlet 50 at an opposite end that is oriented to discharge fluid away from the sprinkler through the opening 24 in the housing side wall 42 to cover an associated ground surface area. In this approach, the flow channel 46 has a generally curved or arcuate shape thereto, such as an elbow shaped configuration, to smoothly direct the flow from the inlet 48 at the bottom of the turret housing 36 to the outlet 50 that extends through the housing side wall 42. In this approach, there are no obstructions or other components in the flow channel 46 that result in or cause unwanted pressure drops in the fluid. The outlet 50 of the flow channel 46 may include an integral nozzle or nozzle portion 52 configured to direct and project fluid outwardly from the sprinkler in a predetermined spray or column, or the outlet 50 may be configured to receive a separate nozzle insert 82, such as that generally shown in FIG. 6.

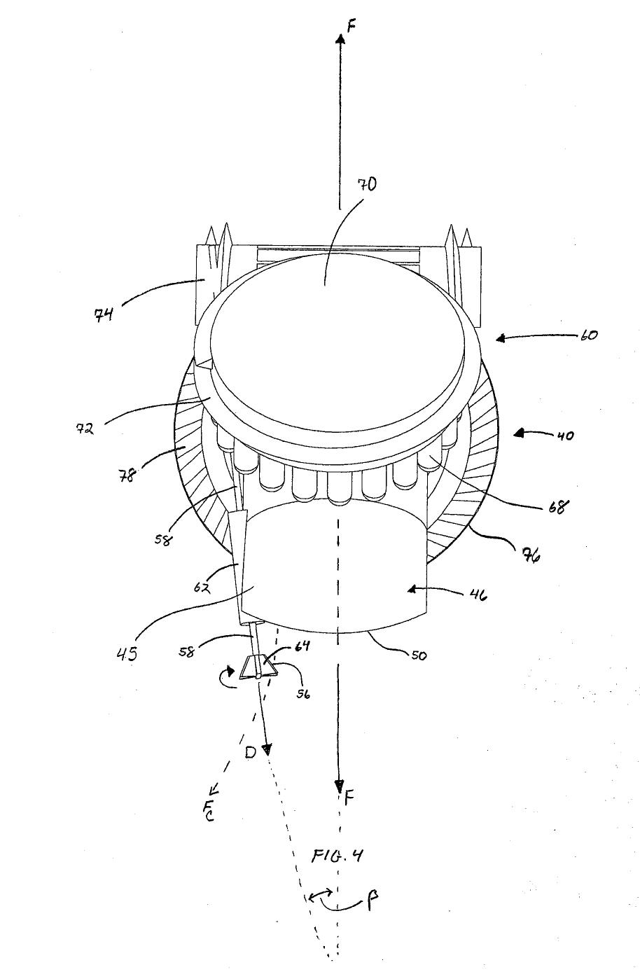

In this first approach, adjacent to the flow channel or nozzle outlet 50 and generally downstream thereof is positioned a main drive element 54 for the drive system 40. By one approach, the main drive element 54 is in the form of a single turbine 56 that is positioned at or adjacent the outlet 50 at a downstream end thereof and oriented so that at least a portion of the turbine 56 engages at least a portion of the fluid projected away from the sprinkler. For example, the turbine 56 may include individual blades or vanes 64 (FIG. 4), and the turbine 56 may be positioned so that that at least one, and preferably, at least half of the vanes 64 are always engaged with or skim the fluid being projected from the flow channel 46. As shown in FIGS. 2-4, the main drive element 54 is positioned on one side 45 of the flow channel 46, but the main drive element 54 also may be positioned at any location adjacent the outlet 50 or a perimeter 51 of the flow channel 46, such as on either side, the top, or bottom thereof, so long as at least a portion of the main drive element 54 is positioned to engage or skim the fluid as it exits the flow channel 46.

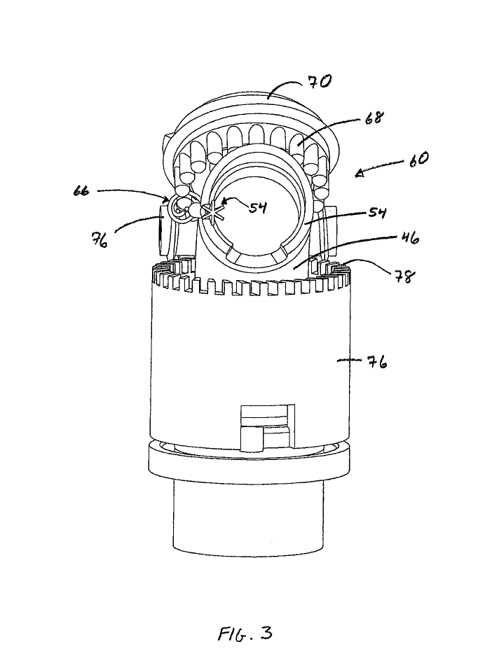

The turbine 56 is coupled to an associated drive shaft 58, which is configured to translate the rotation of the turbine 56 to a compact turret mounted gearing assembly 60, which is configured to effect rotation of the turret 16. The drive shaft 58 is generally an elongated rod or shaft mounted in the turret housing 36 and, by one approach, to the outside of the flow channel 46. In this approach, the drive shaft 58 extends along a drive axis D that is slightly inclined downward relative to a main water flow path F exiting the channel 46, but also extends generally in the same direction as or generally along the main fluid flow path F, as best shown in FIGS. 3 and 4. For example, the drive axis D may be inclined or disposed at an angle β relative to a main flow axis F (which is generally coaxial to the outlet 50) between about 1 to about 10 degrees, and preferably about 3 to about 5 degrees as shown in FIG. 4. By one approach, the drive shaft 58 is rotatably mounted in a bearing 62, which is shown as an exemplary elongate tubular member, located on the side 45 of the flow channel 46; however, the drive shaft 58 may be mounted in the turret housing 36 in any effective manner. By another approach, the drive shaft 58 is constructed from a resilient material, such as a thin wire or rod, so that the drive shaft 58 may flex or bend as needed to push the turbine 56 away from the opening 50 so that a nozzle insert may be installed therein, which will be described in more detail below.

The turbine 56 includes the blades or vanes 64 configured to be rotated by the water flowing past the turbine 56, which then rotates the coupled drive shaft 58 in the same direction. In this approach, the turbine blades 64 are configured so that the turbine 56 rotates about axis D, which is at an angle β, and in this approach in a direction that is generally transverse to the direction of flowing fluid. A portion of the fluid flow (Fc) that engages the turbine blades 64 has its energy reduced due to its impact with the turbine 56. This forms a lower energy flow portion that irrigates close-in sections of an associated ground surface area. Depending on the location of the turbine (i.e., sides, top, or bottom of the flow channel 46), the lower energy flow can be directed to various locations surrounding the sprinkler. Therefore, the position of the main drive element downstream of the nozzle is effective to utilize the pressure drop across the drive motor to also construct a close-in watering flow.

Referring again to FIG. 2, the turret mounted gearing assembly 60 is sufficiently compact to also be completely received within the cavity 44 defined by the turret housing side walls 42 and, at the same time, also be mounted outside of and separate from the fluid flow path inside the flow channel 46. By one approach, the gearing assembly 60 includes a worm gear 66, such as a helical coil, mounted on a distal end 57 of the drive shaft 58. The worm gear 66 is mated with gear teeth 68 of a transfer gear 70 mounted for rotation relative to the flow channel 46. By one approach, the transfer gear 70 may be oriented in an inclined relationship relative to the longitudinal axis X and the turret side wall 42, which orients the gear 70 in a compact configuration to be received within the housing cavity 44. The transfer gear 70 includes helical gear teeth 72 extending circumferentially about an outer surface 73 of the gear 70. The helical gear teeth 72 mate with a secondary worm gear 74, such as an elongate cylindrical worm gear, that transfers the rotation of the spherical gear 70 to a turret support tube or turret cup 76 that has gear teeth 78 extending about an upper end 79. The secondary worm gear 74 mates with the gear teeth 78 of the turret support tube 76. By one approach, the turret support 76 is preferably a cylindrical member that surrounds the flow channel 46 and is coupled to the nozzle turret 16, whereby the turret 16 is mounted for rotation with the turret support 76. In this regard, rotation of the turret support 76 imparts rotation to the nozzle turret 16, which is all generated by the fluid flow downstream of the nozzle and flow channel 46. The sprinkler 10 preferably does not have any drive components in the portions of the sprinkler upstream of the turret 16 and does not have any drive components in the non-rotatable riser body 32 or housing 12.

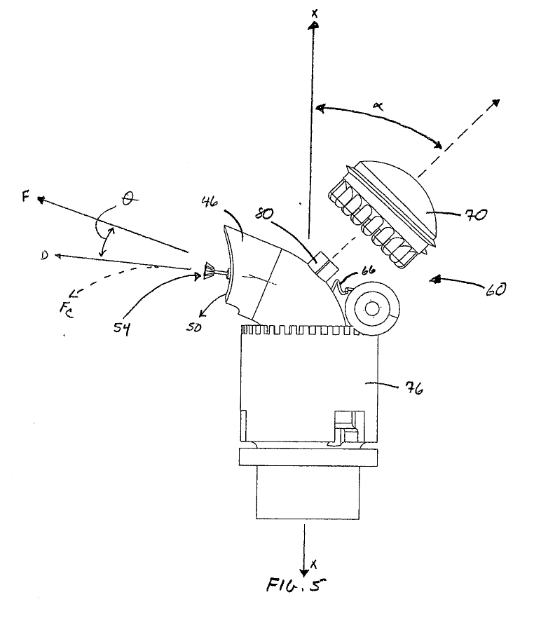

As mentioned above, the complete drive assembly 40 is sufficiently compact to be completely mounted in the cavity 44 defined by the rotary turret housing 36, and only the main drive element 54 is positioned in the water flow path F. To achieve this compact configuration, one embodiment of the drive mechanism 60 orients the transfer gear 70 inclined relative to the axis X and the housing side wall 42. In this approach, the axis of rotation of the gear 70 is oriented about 45° relative to the axis X, as generally shown by the angle α in FIG. 5. To this end, the flow channel 46 may also include a bearing post 80 extending from a rear side thereof to which the gear 70 is coupled to through a depending shaft of the gear 70 rotatably mounted in the bearing post 80.

The drive system 40 may be used with a nozzle that is integral with the flow channel 46 such that an end portion 47 or 52 of the flow channel 46 has a shape configured to form a particular spray or stream pattern (see, for example, FIG. 2). Alternatively, the drive system 40 also may be used with a separate nozzle insert 82 that is configured to be received in the end portion 47 of the flow channel 46 (see, for example, FIG. 6). If the separate nozzle insert 82 is employed, it is preferred that the main drive element 54 also is configured to shift relative to the flow channel end 50 so that the separate nozzle insert 82 may be inserted past the drive element 54 into the flow channel. Shifting of the main drive element is illustrated by the exemplary directional arrow A in FIG. 6. By one approach, the flow channel 46 also may include a guide device or track 84 to direct the main drive element 54 to be shifted from an operable position in the fluid flow path generally along the drive axis D to a retracted or withdrawn position (arrow A) outside of the flow path so that the nozzle insert 82 can be placed or inserted into the flow channel 46. The guides 84 may be slots, rails, tracks, articulating links, or other directional structure that permits the main guide element 54 and drive shaft 58 thereof to be controllably and sufficiently shifted between the two functional or operational positions and out of the way to permit insertion of the nozzle insert 82 into the flow channel 46. Alternatively, the drive shaft 58 of the main drive element 54 may be resiliently bendable, such as in the form of a thin rod formed from metal, plastic and the like, so that the turbine or other drive element can be pushed aside due to the resiliency of the drive shaft for receipt of the nozzle insert 82. It will be appreciated that, as the main drive element 54 can be positioned at different locations adjacent the outlet 50 of the flow channel 46, the shifting of the main drive element 54 can occur in varying directions depending on where the drive element is mounted on the flow channel 46.

Turning again to FIG. 5, the main drive element 54 also may be slightly tilted relative to the main fluid stream or spray F in a generally vertical plane. For example, the drive axis D may be tilted downwardly from the main fluid throw F, such as by about 10 to about 20 degrees, as generally shown by angle θ. This downward tilt of the drive axis D is effective for positioning the turbine 56 to not only be turned by the flow F, but also for forming a lower energy, close-in fluid stream Fc. As mentioned above, this reduced energy stream or spray is achieved through reducing fluid energy by impacting the drive element or a reduction in the pressure drop across the main drive element 54, rather than using structure on the nozzle or flow channel to form this close-in stream or spray. By comparing FIGS. 4 and 5, the main drive element 54 and drive axis D thereof are generally in-line or in the direction of the fluid output F, but are slightly inclined inwardly thereto, as viewed from a horizontal plane, and slightly tilted downwardly thereto, as viewed from a vertical plane. As a result, the output of the sprinkler 10 may include both a primary and mid-range range flow that are projected from upper portions of the nozzle and not contacted by the main drive element 54, and at the same time may have a gentle, lower energy flow that engages or skims the main drive element 54 to produce the lower energy, close in watering flow.

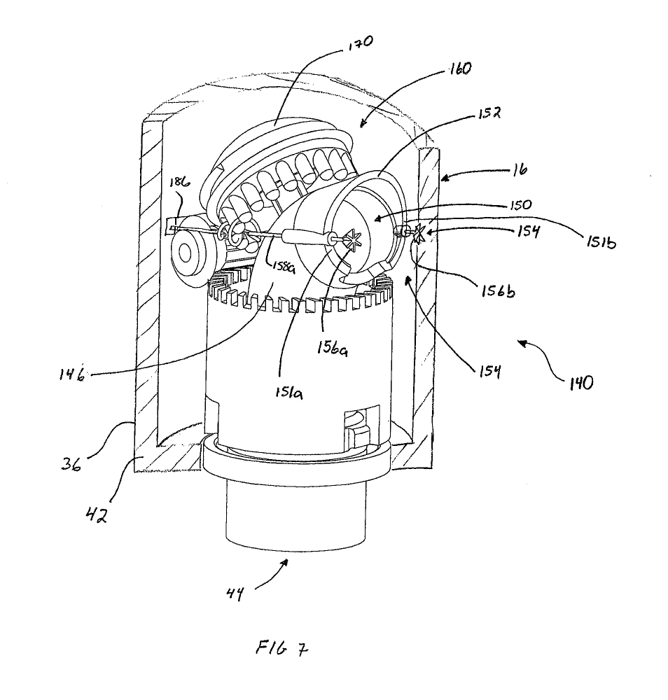

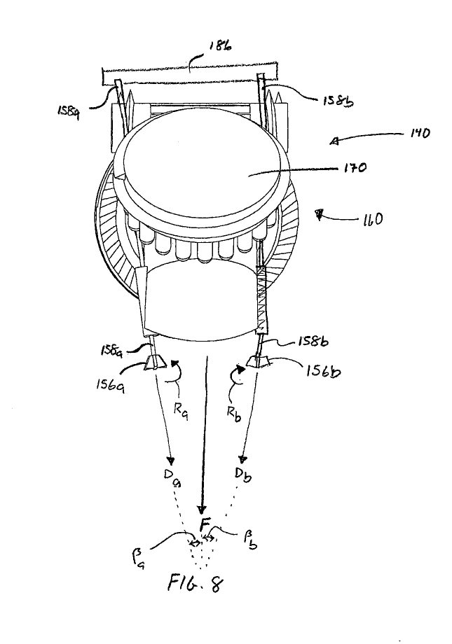

Turning to FIGS. 7 and 8, a second form of a compact turret mounted drive system 140 is shown using a main drive element 154 in the form of a pair of spaced turbines 156a and 156b. This configuration of the drive system 140 is advantageous because it employs dual turbines to achieve reversing rotation of the nozzle turret 16 depending on which turbine 156a or 156b is engaged with a gearing assembly 160 of the drive system 140. This form of the drive system 140 is similar to drive 40, but employs two turbines 156a and 156b, which are preferably spaced on opposite sides 151a and 151b of the flow channel 146 and adjacent an outlet 150 thereof, which may be at a downstream end. Only the differences from the drive system 40 will be described below.

Each turbine 156a, 156b has an associated drive shaft 158a and 158b, respectively, that is mounted in the turret and, preferably, to the flow channel 146 similar to the previous approach. Each drive shaft 158a, 158b also is generally aligned in the direction of the fluid flow and configured to be rotated by the fluid about their respective axes in a direction substantially transverse to the flow, as generally shown by the directional arrows Ra and Rb in FIG. 8. Preferably, each of the pair of turbines 156a, 156b is positioned to engage and/or skim the fluid to be rotated simultaneously with the other but in opposite directions thereof. In this manner, the pair of turbines 156a, 156b can be used as part of a switching mechanism 186 that reverses rotation of the turret 16.

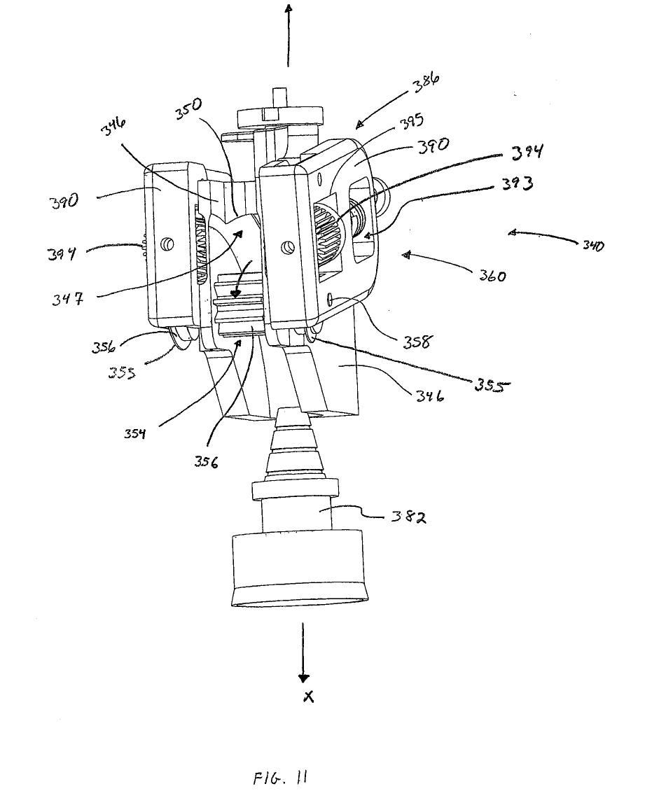

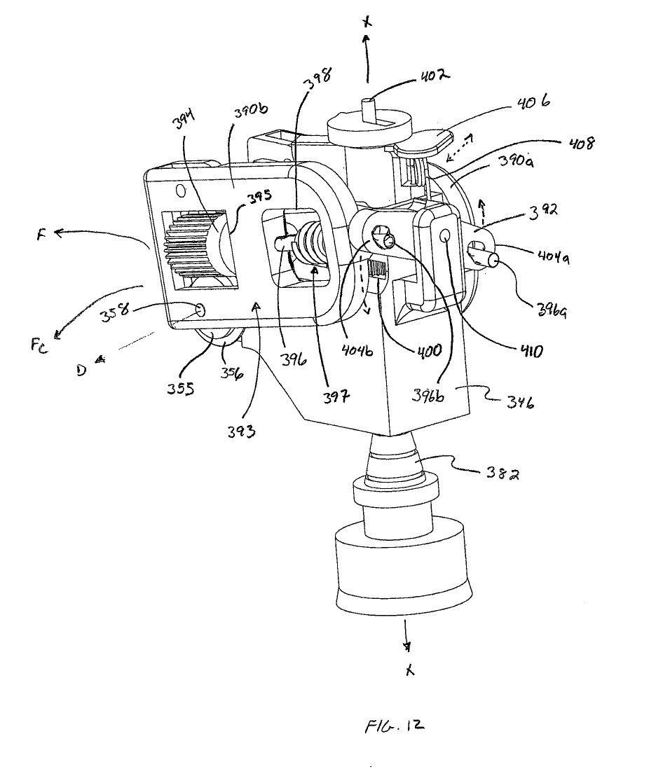

More specifically, the turret 16 may employ a switching mechanism 186 to alternate engagement of the turbines 156a and 156b and their associated drive shafts 158a and 158b with the gearing assembly 160. For instance and by one approach, when the switching mechanism 186 couples the turbine 156a and its drive shaft 158a to the gearing assembly 140, the turret is configured to rotate in a first direction, such as clockwise. Then, when the switching mechanism 186 is tripped and switches engagement with the turbines so that the second turbine 156b and its drive shaft 158b, which rotates in the opposite direction, is coupled to the gearing assembly 160, then the turret 16 is configured to rotate in a second or opposite direction, such as counterclockwise. The switching mechanism 186 and turret 16 may employ any number of toggling levers, switches, gears and the like to alternate engagement between the drive shafts 158a and 158b and the gearing assembly 140. For example, the switching mechanism 186 may raise and lower the drive shafts 158a, 158b from engagement with a transfer gear 170, such as, for example, with the pivot bases or similar structures, as described below with FIGS. 11 and 12. Other types of switching mechanisms also may be used as appropriate.

As with the main drive element 54, each of the drive shafts 158a and 158b extends along an associated drive axis Da and Db, respectively, that extend generally in the direction of the fluid flow, but preferably slightly disposed or inclined thereto, such as inclined or disposed to a main flow axis F extending generally coaxial to an exit of the flow channel. For example, the drive shafts 158a and 158b may be angled inwardly toward each other. By one approach, each drive axis Da and Db is disposed at an angle βa and βb, respectively, between about 1° and about 10° relative to the flow axis F to position at least an inner portion of turbine vanes in at least a portion the fluid flow. In this configuration, both turbines 156a and 156b can be employed to achieve a single close-in watering stream or spray, or the turbines can be oriented in slightly different vertical tilt angles so that each turbine 156a and 156b produces different fluid sprays with varying water energies. For example, the fluid engaging turbine 156a may produce a close-in fluid stream or spray, and the fluid engaging turbine 156b may produce a slightly higher energy stream or spray to project fluid slightly farther from the sprinkler 10 due to the drive axes being disposed or tilted at slightly different angles in a horizontal plane.

Similar to the previous embodiment, this form of the drive system 160 may be employed with a nozzle portion integral with the flow channel 146 or with a separate nozzle insert 82. To this end, the pair of turbines 156a and 156 also may employ one or more shifting mechanisms, as needed, to permit insertion of the removable nozzle insert 82, such as those described above with flow channel 46. The flow channel 146 may use guides 84 on one or both of the turbines 156a, 156b so that one or both of the turbines 156a, 156b may be shifted to allow insertion of the insert 82.

As shown in the figures, the pair of turbines 156a and 156b are positioned on opposite sides of the flow channel outlet 150, but the turbines also may be positioned along other portions of the flow channel sides or perimeter so long as they are adjacent the outlet at a downstream end thereof. For example, the turbines may be at top and bottom sides of the channel 146, or even on the same side of channel 146. Moreover, the inclination and tilt of the drive axes D, Da, and/or Db also may be changed in either a horizontal or vertical direction depending on what particular throw distance, stream energy, or positioning of the close-in stream or spray is desired.

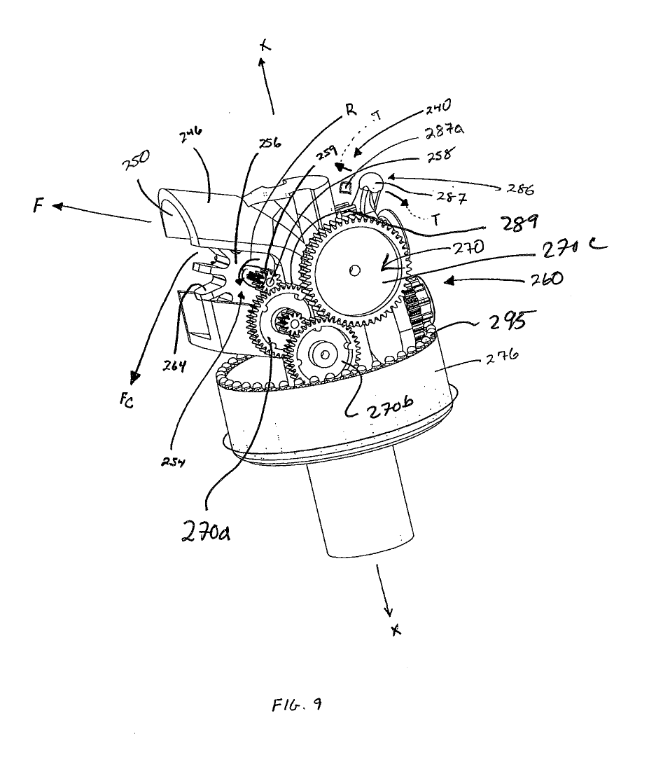

Turning to FIGS. 9-12, other embodiments of compact turret mounted drive systems are illustrated using a main drive element positioned adjacent the flow channel or nozzle outlet at a downstream end thereof, but generally configured to rotate in the direction of a fluid flow (as opposed to the previous embodiments where the main drive element rotated generally transverse to the direction of fluid flow). For example, in this approach, the main drive element has a drive axis D that is generally transverse to the direction of water projected from the nozzle or flow channel instead of being generally in the direction of the fluid flow as in the previous embodiments. In this approach, a paddle wheel configuration of the main drive element may be employed where individual paddles or drive units of the main drive element are configured to throw fluid downwardly from the nozzle for close-in fluid watering. Depending on the desired stream characteristics, a larger or smaller wheel or even multiple wheels may be employed adjacent the flow channel or outlet as the main drive element. In this approach, the fluid flows generally tangentially to the main drive element to both drive the main drive element and reduce the energy of a portion of the fluid stream or spray.

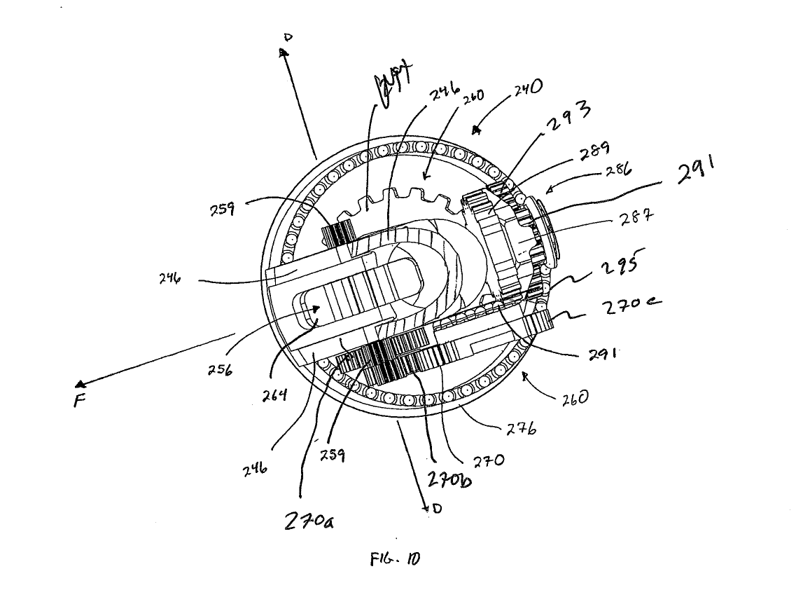

More specifically and referring to FIGS. 9 and 10, a compact turret mounted drive system 240 is shown employing a main drive element 254 in the form of a geared paddle wheel 256 that turns or spins in the direction of fluid flow. It will be appreciated that the compact drive system 240 also may be completely mounted in the cavity 44 of the turret housing 36. The main drive element 254 is mounted adjacent an outlet 250 of a flow channel 246 that directs fluid outwardly away from the sprinkler 10. The flow channel 246 may include a nozzle portion, may accept a separate nozzle insert, or may include an internal nozzle that projects fluid upwardly along the sprinkler's longitudinal axis X (such as those shown in more detail in FIGS. 11 and 12 to be described below). In either instance, the main drive element 254 is positioned adjacent the nozzle or flow channel outlet at a downstream end thereof and mounted in the turret housing 36.

By one approach, the wheel 256 may be in the form of a pelton wheel, where the wheel is configured so that fluid flows generally tangentially to paddles, blades, or other drive units 264 of the wheel 256. Preferably, the wheel 256 includes a plurality of paddles 264 extending radially outwardly therefrom. During operation, fluid flow is directed through the flow channel 246 and directed by the flow channel to engage the wheel 256 tangentially and, in particular, to contact the paddles 264 thereof to turn the wheel 256 generally in the direction of fluid flow (as shown by arrow R in FIG. 9). At the same time, the fluid engaging each paddle 264 is also decelerated and routed in a downwardly, curved direction (as viewed from a generally horizontal plane) so that fluid that has contacted the wheel 256 also exits the nozzle or flow channel 246 in a downwardly direction Fc from a main fluid flow F to produce a lower energy, close-in watering spray or stream. As mentioned above, the main drive element 254 in this embodiment is mounted to a drive shaft 258 extending along a drive axis D that is generally transverse to the direction of main fluid flow F, as best shown in FIG. 10.

As also shown in FIGS. 9 and 10, this approach of the drive system 240 employs a compact gearing assembly 260 incorporating generally vertically oriented transfer gears to transmit the rotation of the main drive element 254 to rotate the turret 16. For example, the drive shaft 258 includes a pair of pinion gears 259 on opposite sides thereof that engage a gear reduction system 260 that also is completely mounted in the turret housing 36. The gear reduction system 260 in this approach employs a set of generally vertically oriented drive and transmission gears 270 that transmit and reduce the rotational speed of the main drive element 254 and impart a much slower rotation to a main turret body 276 (which is coupled to the turret 16). More specifically, the transmission gears 270 include a first compound gear 270a, which has a larger spur gear in driving engagement with the primary gear 259 and a smaller spur gear in driving engagement with a transfer gear 270b. The transfer gear 270b is in driving engagement with a spur gear of a second compound gear 270c. The second compound gear 270c also has a series of cogs on one side that engage a toggle gear 289 that is pivoted between this gearing assembly 260 and an identical one on the other side. The toggle gear 289 drives an upper spur gear 291, which, in turn, drives a rear compound drive gear 293. The rear gear 293 also meshes with a series of cogs 295 to rotate the turret.

As best shown in the partial cross-sectional view of FIG. 10, the drive system 240 preferably includes an intermediate switching mechanism 286 in the form of a toggle lever 287 that is configured to toggle or pivot the toggle gear 289 into alternative engagement with either of the drive gears 270 on opposite sides of the flow channel 246. When the toggle lever 287 is shifted to one side (arrows T in FIG. 9) via a tab or other trigger mechanism 287a carried by the turret, the toggle gear 289 is shifted in the same direction so that it mates with gear cogs 291 of the drive gear 270 on one side of the flow channel 246 to rotate the turret 16 in one direction. When the toggle lever 287 is shifted in the opposite direction, the toggle gear 289 mates with the gear cogs 291 of the drive gear 270 on the opposite side of the flow channel 246, and the turret 16 is then configured to rotate in the opposite direction.

Similar to the previous approach, all components of this drive system 240 are mounted in the housing 36 of the turret 16. Only the main drive element 254 is positioned in the fluid flow path and the remaining components of the gearing assembly 260 are spaced from and outside of the fluid. In one approach, the drive system 240 may also include similar gearing 260 on both sides of the flow channel 246.

Turning now to FIGS. 11 and 12, another approach of using a compact turret mounted drive system 340 is shown. In the views of FIGS. 11 and 12, only the drive system 340 and nozzle 382 are shown. It will be appreciated, however, that the complete drive system 340 and nozzle 382 shown in these view also may be mounted in the cavity 44 formed in the turret housing 36 similar to the previous embodiments or other housings for rotary-type sprinklers.

In this approach, a gearing system 360 and switching mechanism 386 are employed together with a main drive element 354, which also is configured to rotate in the direction of a tangential fluid flow similar to the wheel 256 of the previous approach. Here, the main drive element 354 is a relatively smaller paddle-type wheel 356 and positioned at a lower portion of the flow channel's outlet 350. As with the other approaches, the main drive element 354 is adjacent the flow channel or nozzle outlet 350 at a downstream end thereof. Similar to the previous approaches, only the main drive element 354 is positioned to engage or skim the fluid while the rest of the gearing system 340 is separate from and spaced from the fluid flow path.

In this approach, the nozzle 382 is oriented along the sprinkler's longitudinal axis X so that the nozzle projects a fluid flow in a generally horizontal direction along the axis X. The flow channel 346 in this approach then functions as a deflector that is configured to deflect or redirect the horizontally directed fluid via a curved or arcuate deflecting portion 347 from the generally horizontally direction to an outwardly configured direction away from the sprinkler 10. The main drive element 354 is then positioned in the flow channel 346, such as in a lower portion thereof, to engage or skim a portion of the redirected flow for powering the drive motor of the sprinkler. Similar to the wheel 256, the main drive element 354 of this approach is a paddle wheel 356 configured to be turned by a tangential flow generally in the direction of fluid flow.

The gearing system 340 of this approach also is sized to be received in a rotatable housing and configured to turn the sprinkler turret 16 is reversing directions. To this end, the drive system 340 uses a pair of left and right pivot bases 390 positioned on opposite sides of the flow channel 346. The pivot bases 390 are arranged and configured to pivot up and down in a generally vertical plane in opposite directions due to engagement with a trip lever or toggle arm 392 (FIG. 12), which reverses direction of the turret 16.

More specifically, the main drive element 354 rotates about a drive shaft 358 (oriented generally transverse to the flow of fluid) and engages a worm cluster 393 received in each of the left and right pivot bases 390. Each worm cluster 393 including a primary worm gear 394 mounted in a first or forward window 395 of each pivot base 390. Each primary worm gear 394 is rotated by the main drive element 354 via a transfer pinion gear 355 having circumferential grooves 356 on an outer surface thereof that mate with corresponding grooves on the primary worm gear 394. Each primary worm gear 394 is rotated simultaneously, but in opposite directions thereof.

Each primary worm gear 394 then turns a transverse drive shaft 396 of the worm cluster 393 that extends rearwardly from the primary worm gear 394 in the pivot base 390 to the rear of the drive system 340. Each transverse drive shaft 396 includes a secondary worm gear 397 positioned at a distal end thereof and disposed in a second window or opening 398 of the pivot bases 390. The secondary worm gear 397 is arranged and configured to mate in an alternating fashion with a central drive gear 400 (FIG. 12) based on the vertical position of the distal ends of the left and right pivot bases 390, which will be explained in more detail below. The central drive gear 400 then turns a central drive axis 402 that transmits rotation to the turret 16. Alternatively, a distal end of each drive shaft 396 also may be coupled to a gearing system or other transfer mechanism (not shown) that transmits its rotary motion to the turret 16 via a support tube or other gearing system similar to any of the previously described approaches.

To effect reversing operation of the turret 16, the transverse drive shafts 396 of each worm cluster 393 are each received in opposite ends 404a and 404b of the toggle arm 392, as shown in FIG. 12. The toggle arm 392 is configured to shift the distal ends of the right and left pivot bases (i.e., 390a and 390b) and their corresponding drive shafts 396 in an alternating fashion up and down in a generally vertical motion based on the pivoting of the toggle arm ends 404a and 404b. For example, when the right pivot base 390a is toggled down as shown in FIG. 12, due to the arm 392 being pivoted to the right so that end 404a is shifted downwardly, the secondary worm gear 397 of the right transverse drive shaft 396a engages the central drive gear 400, and the turret 16 turns in a first direction. In this position, the left pivot base 390 is shifted upwardly so that its secondary worm gear 397 is disengaged from the central drive gear 400.

When a shift lever 406 is engaged by a trip tab or other member of the turret (not shown), the lever 406 is shifted and a bias member or coil spring 408 urges the toggle arm 392 to pivot about a pivot axis 410 to shift the right pivot base 390a up (and with it the right transverse drive shaft 396a) to disengage the right secondary worm gear 397 from the central drive gear 400. At the same time, the left toggle base 390b is pivoted downwardly (and with it the left transverse drive shaft 396b) so that the left transverse drive shaft 396b and its associated secondary worm gear 397 then engages the central drive gear 400 to turn the turret in the opposite direction.

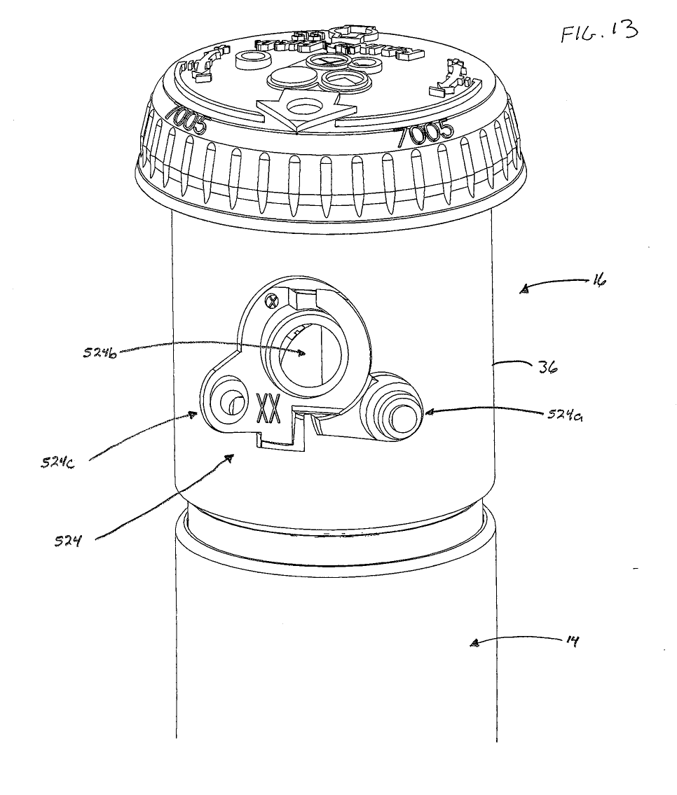

Turning now to FIGS. 13 to 22, another exemplary form of a compact, turret mounted drive system 540 is illustrated. In this approach, the drive system 540 may allow the turret 16 to include a turret outlet 524 with at least one and, preferably, a plurality of outlets or nozzles 524, as shown in FIG. 13. One of the outlets projects a fluid stream that is also used to drive or rotate the turret, and the other outlets are used for fluid streams that bypass the drive system. For example, the outlet 524 may include a close-in flow outlet or nozzle 524a, a primary flow outlet or nozzle 524b, and a tertiary or intermediate flow outlet or nozzle 524c. As will be discussed in more detail below, each outlet 524 may be in fluid communication with a separate flow passage or channel 525 defined internally in the turret 16 and is configured to project separate fluid streams at varying distances from the sprinkler.

More specifically, the turret 16 defines at least the outlet 524a with an internal drive flow passage 525a in fluid communication therewith. This fluid passage and outlet are arranged and configured so that a portion of the fluid entering the turret 16 is used to first power rotation of the turret and then be projected from the sprinkler to irrigate a portion of the surrounding ground surface area. In one approach, this flow stream from the outlet 524a may be a low-energy stream to water close-up areas to the sprinkler.

In addition, the turret 16 also may define a primary flow passage 525b that is in fluid communication with the primary outlet 524b. If used, this passage and outlet may be arranged and configured to allow a fluid stream to bypass the drive channel 525a to form a fluid stream that does not have its energy reduced by engagement with the drive system. Thus, the passage 525b and outlet 524b may project a second fluid stream a relatively far distance from the sprinkler for watering distances remote therefrom. A third flow passage 525c may be defined in fluid communication with the third or intermediate outlet 524c, where both are generally arranged and configured to project a third, separate flow stream an intermediate distance from the sprinkler. The third flow passage 525c may also bypass the drive system. While the turret 16 in this approach is shown with the three separate outlets 524 and passages 525, any number of outlets and flow passages may be used in combination with the outlet 524a and drive passage 525a.

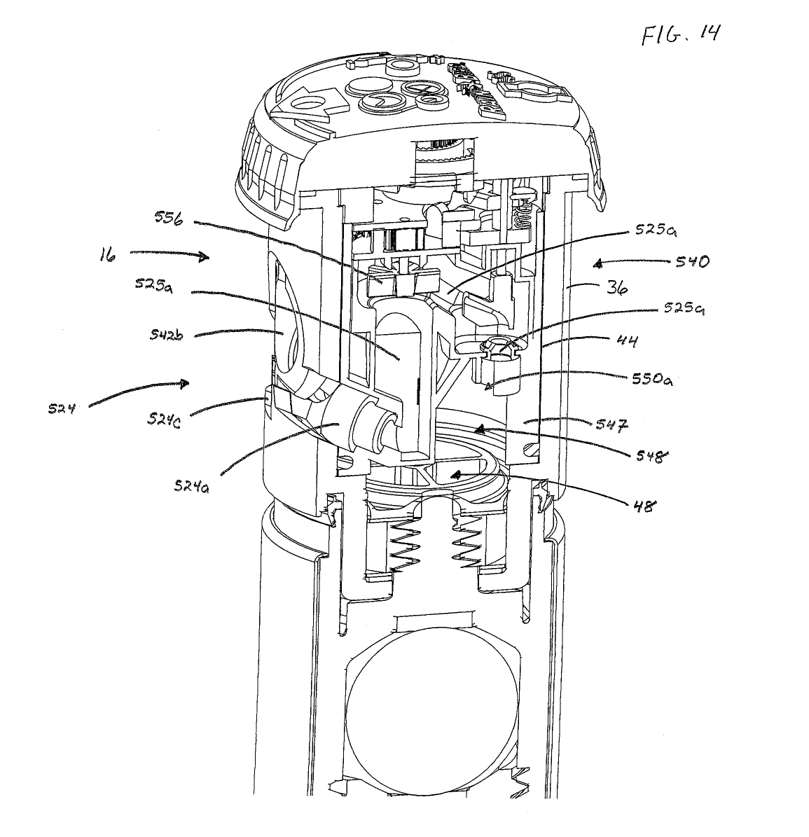

FIG. 14 is a cross-sectional view of the turret 16 including the drive system 540 and passages 525. In this approach, the fluid entering the turret inlet 48 is portioned into the three separate flow channels 525a, 525b, 525c that direct fluid to each of the outlets 524a, 524b, 524c, respectively. To this end, the turret 16 may also include a module or cartridge 547 received in the internal housing cavity 44 in which the flow channels 525 are defined in. The cartridge 547 may be mounted or fixed to the turret 16 and operably coupled to the riser in a rotating manner to be discussed in more detail below.

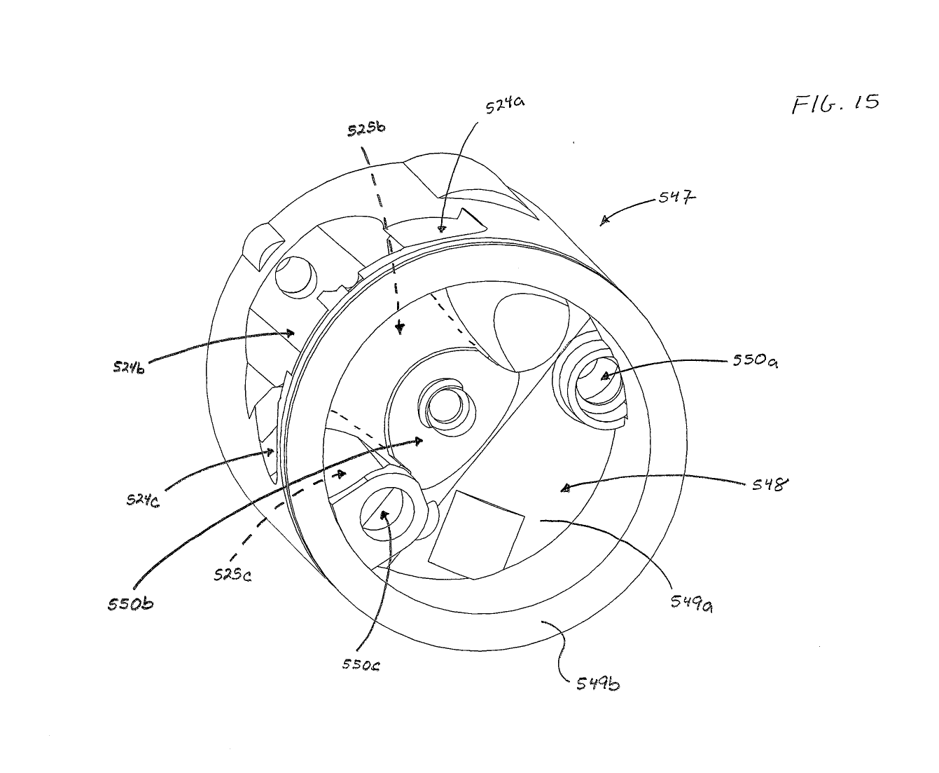

Turning to FIG. 15 for a moment, an exemplary cartridge 547 is shown in more detail. To portion the fluid entering the turret 16, the cartridge 547 defines a lower plenum or fluid collecting chamber 548 positioned to receive fluid from the turret inlet 48. The plenum 548 is defined by an upper module wall 549a and an annular side wall 549b. The upper wall 549b further defines three internal flow outlets 550a, 550b, and 550c. Each outlet 550a, 550b, 550c is in fluid communication with one of the flow passages 525a, 525b, 525c, respectively. For example, the outlet 550a is arranged and configured to direct a portion of the fluid from the plenum 548 to the drive flow passage 525a to direct the fluid first to a main drive element 556 of the drive system 540 positioned within the passage 525a and then to the outlet 524a. As discussed in more detail below, the fluid flowing through this passage and past the drive element 556 powers rotation of the turret 16.

If used, the outlet 550b may be arranged and configured to direct fluid from the plenum 548 to the flow passage 525b and outlet 524b. Preferably, the outlet 550b and flow passage 525b are defined with a minimum of obstructions, restrictions, or direction changes to provide a high-energy flow stream to the outlet 524b. For example, the outlet 550b and/or the flow passage 525b may have a generally smoothly contoured profile such as a generally elbow shaped conduit to direct a fluid flow from the plenum 548 in a manner that minimizes energy loss. If used, the outlet 550c may be arranged and configured to direct fluid from the plenum 548 to the flow passage 425c, which may include features, obstructions, or restrictions to decrease the flow rate and/or pressure of the fluid in this passage to form an intermediate energy flow stream to project fluid from the outlet 524c an intermediate distance flow stream to water ground surface areas at intermediate distances from the sprinkler, i.e., primarily between the discharge from the outlets 542a, 524b.

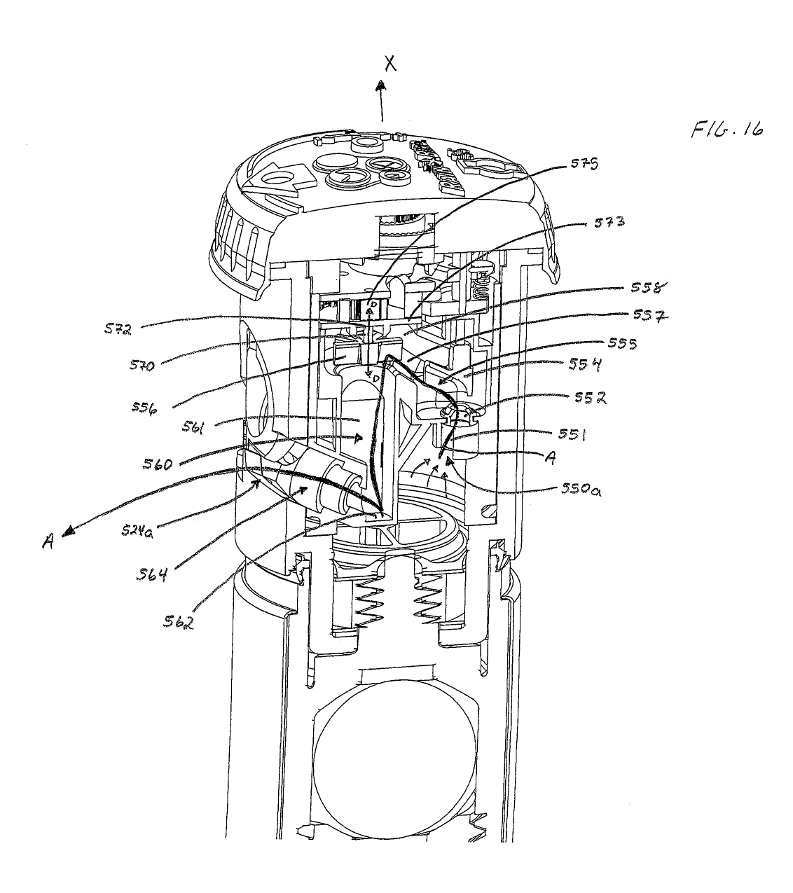

Referring to FIGS. 14 and 16, a flow path of the drive passage 525a in illustrated in more detail. In this approach, the outlet 550a from the plenum 548 leads to an initial conduit segment 551 that generally extends parallel to the longitudinal axis “X” of the riser and ends at an internal flow port 552. The port 552 may be constructed to form a nozzle to increase the flow velocity of the fluid in this section of the drive passage 525a. In some approaches, the flow port 552 may also function as a regulator valve. Under pressure the flow port 552 may increase in diameter, thus increasing the exit area and decreasing the fluid velocity, which decreases the rotation speed of the drive element. With this approach, the flow port may be made from a flexible material, such as thermoplastic elastomer. This has the advantage of simplicity, where the nozzle and regulator valve are combined into one part, eliminating the need for a spring or other biasing element to function with a valve. Next, the port 552 directs the fluid to a flow director 554, which is shaped and contoured to redirect the flow upward and transverse to the direction of the X axis toward the main drive element 556 of the drive system 540. By one approach, the flow director 554 is mounted to the module 547 in a manner where it can toggle or pivot back and forth between two positions to alter the direction of the flow toward the main drive element 556 for reversing rotation of the nozzle turret.

More specifically, the flow director 554 may define a contoured flow channel, such as an inverted U-shaped passageway to redirect the flow; however, other shapes and configurations are also possible. By one approach, the flow director 554 includes a generally elbow shaped spout 555 for smoothly re-directing the upwardly flowing fluid from the regulator valve 552 to an intermediate or transverse portion 557 of the main drive passage 525a. The intermediate or transverse portion 557 then directs the fluid to a main drive cavity 558, which houses the main drive element 556.

As with the other embodiments, the main drive element 556 may be a turbine, paddle wheel, or the like. Preferably, the main drive element 556 is a turbine mounted for rotation in the cavity 558 about a drive axis D generally parallel to the housing longitudinal axis X, as shown in FIG. 16. The fluid flowing through the transverse passage portion 557 impacts the turbine and the individual blades thereof to rotate the turbine about the drive axis D. The fluid then flows downwardly through a chute 560 positioned below the main drive cavity 558. The chute 560 is defined by a generally cylindrical wall 561 and has a fluid impact surface 562 at its bottom, which is opposite the main drive cavity 558. The fluid flowing downwardly through the chute 560 engages the impact surface 562 and is routed to an outlet portion 564 of the main drive passage 525a. The outlet portion 564 leads to the outlet or nozzle 524a. The outlet 524a, in some instances, may be beneficial to provide close-in watering because the fluid flow through flow passage 525a loses considerable energy due to the changing of directions and the driving of the drive element 556. As shown in FIG. 16, the flow arrow A generally illustrates the flow of fluid flowing through the drive passage 525a.

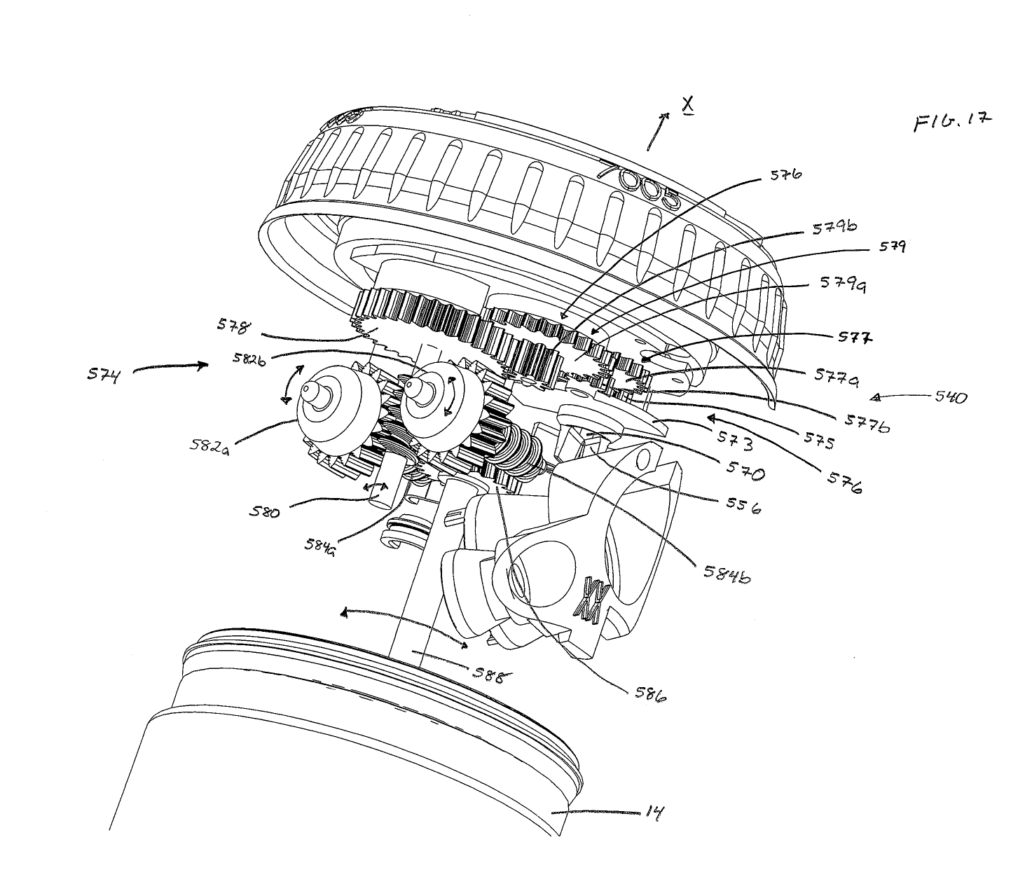

Again referring to FIG. 16, the drive element 556 turns a drive shaft 570 that extends through a sealed port 572 in a top wall 573 forming a turbine housing cover of the main drive cavity 558. The drive shaft 570 is coupled to a gearing assembly 574 (FIG. 17) mounted in an upper portion of the cartridge 547. By one approach, the drive shaft 570 is directly coupled to a relatively small first pinion gear 575 (FIG. 16). As described in more detail below and show in FIG. 17, the gearing assembly 574 includes a number of meshing gears 576 to reduce the relatively high rotational speed of the drive element 556 and first pinion gear 575 to a relatively slower rotational speed for rotating the nozzle turret 16 that is suitable for irrigation.

Turning now to FIG. 17, the gearing assembly 574 of the drive system 540 is shown with the cartridge 547 removed so that the gearing is more clearly seen. In one approach, the gears 576 are sized and meshed in a manner to function as a gear reduction system to produce a slower rotational speed. The gears include two compound gears 577 and 579. Each compound gear 577 and 579 includes a larger gear 577a and 579a and a smaller gear 577b and 579b. The larger and smaller gears rotate about the same axis and are fixed to one another. The first pinion gear 575 meshes with and drives larger gear 577a, which, in turn, rotates the smaller gear 577b. The smaller gear 577b meshes with and drives the other layer gear 579a, which, in turn, rotates the other smaller gear 579b. The smaller gear 579b meshes with and drives the final drive gear 578. The drive gear 579 is connected to a worm gear 580 with a shaft. The drive gear 578 rotates the shaft to turn the worm gear 580. The worm gear 580 is arranged and configured to transfer the rotation of the final drive gear 578, which is about an axis generally parallel to X axis, to a pair of spur gears 582a and 582b which each rotate about an axis that is generally transverse to the X axis. In this approach, the two spur gears 582a, 582b are used to reduce the stress at the interface with the worm gear 580 because this connection may be a relatively high torque interface due to the rotational speeds of the drive system. Optionally, the drive system may also include only one spur gear, or even additional spur gears, depending on the application and rate of rotation needed. By one approach, the gearing assembly may be configured for about a 2,000:1 to about a 12,000:1 gear reduction. That is, the gearing assembly can convert about 2,000 to about 10,000 rpms of the drive element 556 to about 1 rpm of the turret 16.

Each spur gear 582a, 582b is coupled to a worm gear 584a, 584b that extends generally inwardly relative to the housing cavity and oriented transverse to the longitudinal axis X. The worm gears 582a, 582b are meshed with a turret drive gear 586 that is fixed to a central turret shaft 588, which also is fixed against rotation relative to the riser 14. Thus, as the spur gears 582a, 582b rotate (via rotation of the turbine 556 and gearing assembly 576), the transverse worm gears 584a, 584b also rotate in the same direction. The worm gears 548a, 548b are meshed with the gear 586 so that as they rotate they crawl around the fixed gear. This, in turn, causes the turret 16 to rotate about the central X axis because the gearing assembly is fixed for rotation with the turret 16.

As shown, the spur gears 582a and 582b may optionally be positioned off plane from each other so that each gear 582a and 582b is positioned in a different horizontal plane in the turret housing 36. This may be advantageous because it allows different portions of the fixed gear 586 to be engaged by one of the transverse worm gears 584b or 584b. For example, the worm gear 584a may be positioned in a slightly higher horizontal plane so that it engages an upper portion of the fixed gear 586. The worm gear 584b may be positioned in a slightly lower horizontal plane so that it engages a lower portion of the fixed gear 586. Of course, if both worm gears 584a and b are used, they also may be included in a similar plane or reversed in positioning. This is advantageous because it may reduce the wear on the main fixed gear 586 when both spur gears are used.

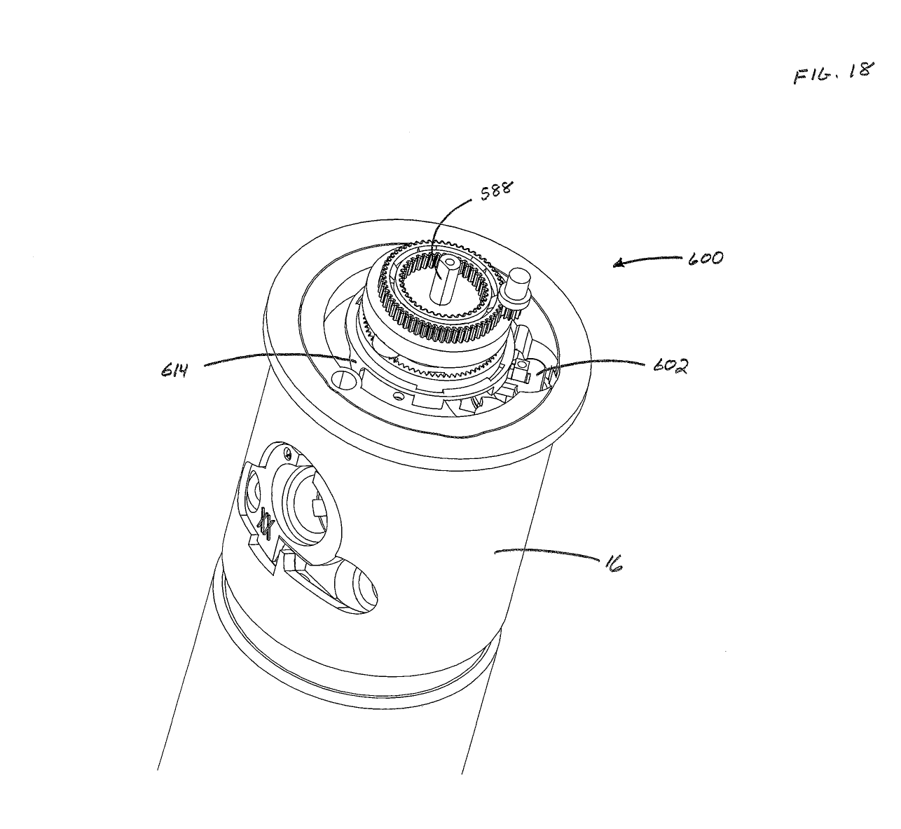

Turning now to FIGS. 18 to 22, an exemplary reversing mechanism 600 suitable for the compact, turret mounted drive system 540 is illustrated. It is to be appreciated that the reversing mechanism 600 is but one example and other configurations also may be employed. The reversing mechanism 600 in this approach is fixed to the central turret shaft 588 against rotation, except when being adjusted by a user, so that the turret 16 rotates independent of the reversing mechanism 600. Such configuration is in contrast to prior reversing mechanisms used with drive systems located in the riser where the reversing mechanisms tend to rotate with the turret.

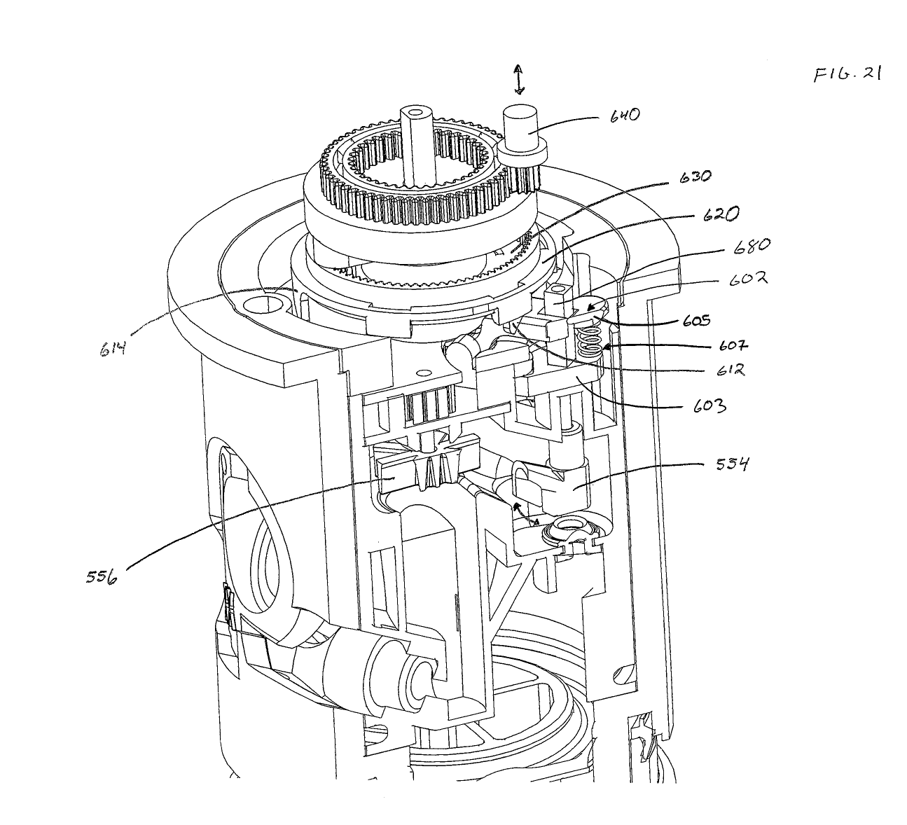

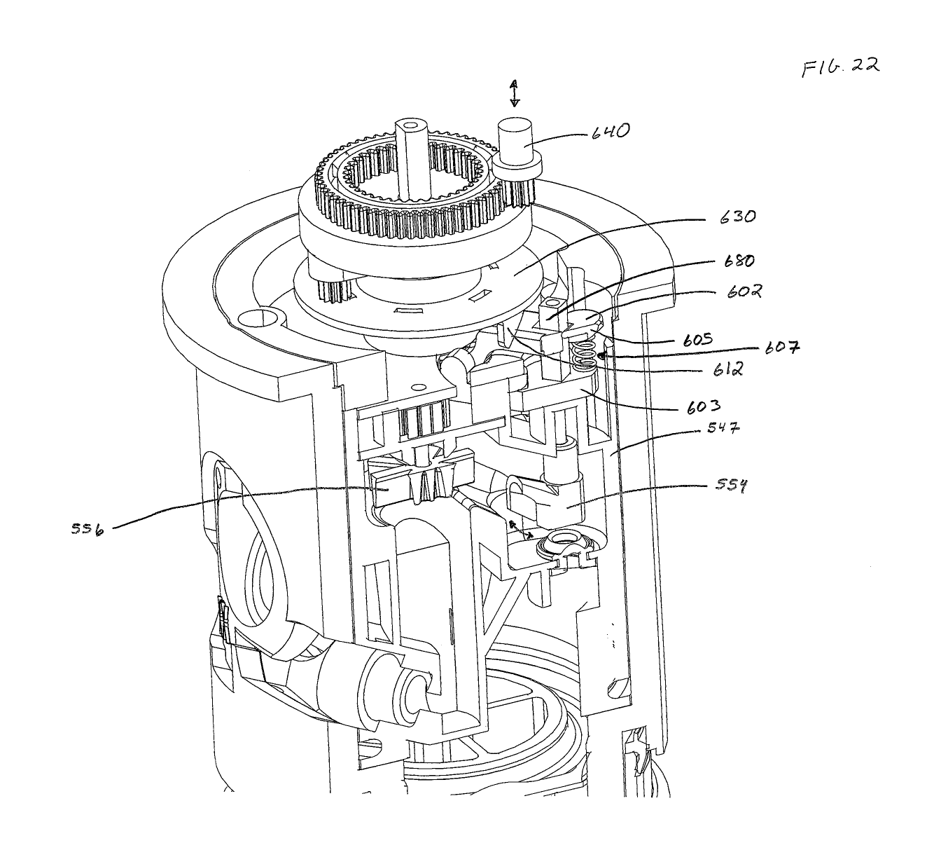

As shown in FIG. 18, the rotating turret 16 is shown with its top cover removed so that portions of the reversing mechanism 600 are visible. In this approach, the reversing mechanism includes an actuator lever 602 that is operably connected to the flow director 554 within the main drive passage 525a, as will be discussed further below with respect to FIGS. 21 and 22. The lever 602 is arranged and configured to toggle back and forth between two positions to change the orientation of the flow director 554 so fluid is directed to one side or the other of the main drive element 556. By changing the direction of fluid flow towards the main drive element 556, the direction of rotation of the main drive element 556 and, thus, the turret 16 can be reversed.

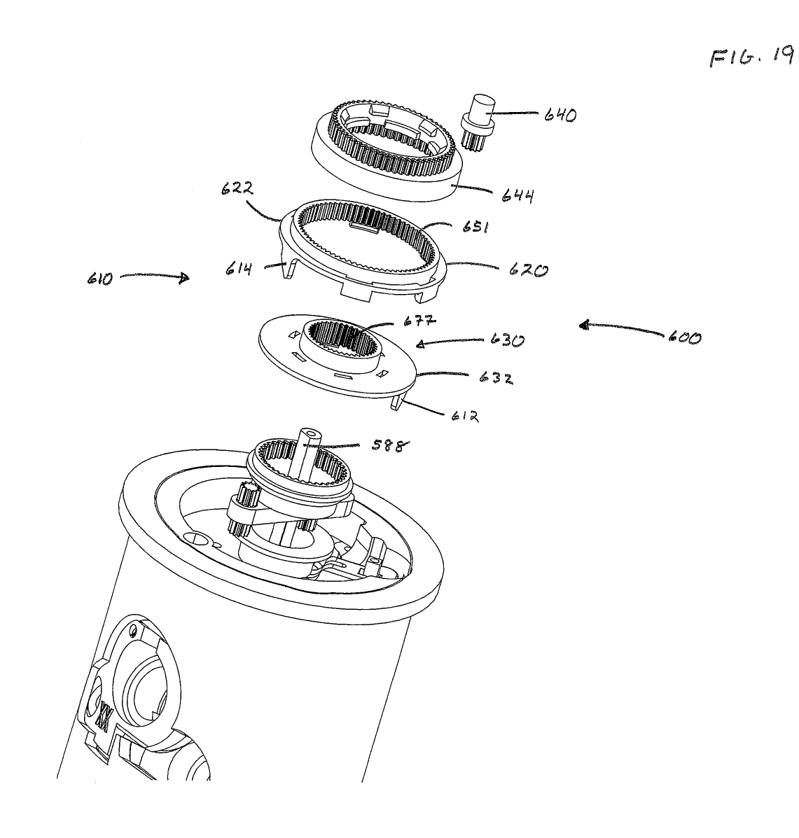

To reverse direction of the turret rotation, the reversing mechanism 600 may include a tripping system that includes a pair of spaced trip arms 610 positioned circumferentially about an upper portion of the flow module 547, as best shown in FIGS. 19-22. For example, the tripping system may include a left trip arm 612 circumferentially spaced from a right trip arm 614. Except when being adjusted by a user, the trip arms 610 are fixed relative to the rotating turret 16. The trip arms 610 are positioned in an operational plane so that they can engage the trip lever 602 as the actuator lever 602 rotates about the longitudinal axis X and central shaft 588 with the turret 16. This is generally opposite traditional reversing mechanisms found in riser mounted drive systems where the trip lever remains fixed and the trip tabs are rotated.

In particular, as the turret 16 and trip lever 602 rotate, engagement of one of the trip arms 610 with the trip lever 602 causes the lever 602 to toggle one way to move the flow direction 554 to one position for one direction of rotation, and engagement of the other trip arm causes the lever 602 to toggle to the other direction to move the flow direction 554 to the other position for opposite rotation. By one approach, the lever 602 and flow director 554 pivot back and forth about 20° to about 30°, but other ranges of pivoting also may be suitable.

In one approach, the reversing mechanism 600 may include a right trip arm ring 620 fixedly mounted to the central shaft 588, except when adjusted by a user. The ring 620 includes the right trip arm 614 depending from an outer circumferential edge 622, as shown in FIG. 19. The tripping system also may include a left trip arm 630 also fixedly mounted to the central shaft 588, except when adjusted by a user, as also shown in FIG. 19. In addition, FIGS. 21 and 22 show the relationship of the rings 620 and 630 relative to the trip lever 602 and module 547. For clarity, FIG. 21 is shown with the right trip arm ring 620 in place, but FIG. 22 is shown with the right trip arm ring 620 removed so that the left trip ring 630, which may be nested with the ring 620, is more visible.

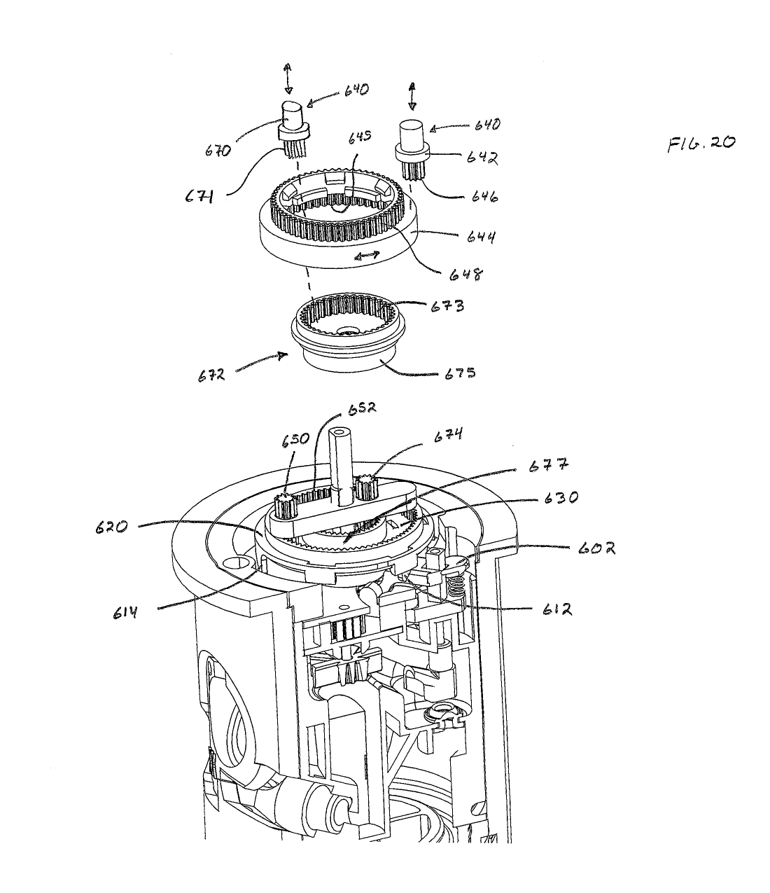

As shown in FIG. 20, one or more adjustment members 640, such as an adjustment screw, may be accessible through the top cover of the sprinkler to adjust either the left or right trip arms 612, 614. A right adjustment screw 642 may be provided so that it can be shifted into a gearing relationship with a right drive ring 644. That is, during normal operation, the right screw 642 may be biased, such as by a spring, to a spaced relationship from the coupling 644 so that the ring 620 and its associated drive ring 644 remain fixed to the shaft 588. To adjust the right trip arm 614, the screw 642 may be manually depressed against the upward biasing force so that a lower geared portion 646 of the screw 642 engages trip arm 614, an outer gear 648 of the drive ring 644. Then, turning the screw 642 effects a turning of the drive ring 644. The drive ring 644 includes an inner gear 645 that meshes with and drives a pinion gear 650. The pinion gear 650 also meshes with and drives an inner gear 652 on the right trip arm ring 620, which also causes the right trip arm ring 620 to turn in a similar direction. Thus, the ring 620 can be shifted or turned about the central longitudinal axis X to shift the right trip arm 614 circumferentially.

Another adjustment screw 670 may be provided to couple with a left ring adjustment drive ring 672, which may be concentrically mounted with the right adjustment drive ring 644, to adjust the left trip arm ring 630 in a similar manner using a second pinion transfer gear 674. More specifically, the adjustment screw 670 includes a lower geared portion 671 that can engage with an inner gear ring 673 of the drive ring 672. The drive ring 672 includes a second inner gear ring 675 that meshes with and drives the second pinion transfer gear 674, which, in turn, meshes with and drives an inner gear 677 of the left trip arm ring 630 to move the left trip arm 612. The left adjustment screw 670 also is normally biased, such as with a spring, out of engagement with the inner gear ring 673. To actuate, the screw 670 is pressed down against the bias to engage the inner gear ring 673 and then turned.

More specifically, the trip lever 602 includes a base 603 and a lever 605 hinged to the base. The opposite ends of the base 603 and lever 605 are separated by a pair of springs 607. The base 603 and lever 605 both define a square hole through which the square shaft sleeve 680 extends. The hole in the lever 605 is large enough to provide a clearance with the shaft so that the lever can bias downward when engaged by the trip arms 612, 614 in excessive force situations. This prevents vandalism to the trip arms, i.e., so that trip arms will not break off.

As best shown in FIGS. 21 and 22, the trip lever 602 is connected to the flow director 554 via a shaft sleeve 680 that extends through the upper wall of the module 547. Thus, as the trip lever 602 is toggled back and forth as it engages one of the trip arms 610, the flow director 554 also is toggled within the channel 525a in a similar manner, as generally shown by the directional arrows in FIGS. 20 and 21. When the flow director 554 is toggled to a first operational position, it is configured to direct a fluid flow to one side of the turbine 556 to cause it to turn in either a clockwise or counter-clockwise direction. When the flow director is togged to its second position, it is configured to direct fluid flow to the opposite side of the turbine to cause it to turn in an opposite direction for reversing rotation of the nozzle turret.

It will be understood that various changes in the details, materials, and arrangements of parts and components which have been herein described and illustrated in order to explain the nature of the sprinkler may be made by those skilled in the art within the principle and scope of the sprinkler as expressed in the appended claims. Furthermore, while various features have been described with regard to a particular embodiment or a particular approach, it will be appreciated that features described for one embodiment also may be incorporated with the other described embodiments.

What is claimed is:

1. A rotary sprinkler comprising:
a body having a longitudinal axis and configured to communication with a source of fluid;
a turret rotatably mounted to the body and having a wall surrounding the turret and defining a cavity;
at least one flow channel extending through the cavity and having an outlet thereof communicating with an opening defined in the turret housing wall for projecting fluid from the rotary sprinkler; and
a drive system mounted in the cavity of the turret housing to rotate the turret relative to the body and comprising a main drive element mounted in the at least one flow channel to be engaged by fluid flowing therethrough the flow channel so that the fluid moves the main drive element, and
a gearing assembly coupled to the main drive element and the turret so that movement of the main drive element effects rotation of the turret.

2. The rotary sprinkler of claim 1, wherein the main drive element comprises a turbine having a drive shaft extending along a rotary axis.

3. The rotary sprinkler of claim 2, wherein the rotary axis is inclined relative to a general fluid flow direction of the fluid engaging the turbine.

4. The rotary sprinkler of claim 3, wherein the rotary axis is inclined about 1° to about 10° relative to a general fluid flow direction.

5. The rotary sprinkler of claim 1, wherein the gearing assembly includes a gear operably coupled to the main drive element, the gear being configured to transfer rotary motion of the main drive element to effect rotation of the turret and oriented relative to the longitudinal axis of the body so that the gearing assembly can be completely mounted in the turret.

6. The rotary sprinkler of claim 5, wherein the gear is oriented at an inclined angle relative to the longitudinal axis of the body.

7. The rotary sprinkler of claim 1, wherein the main drive element includes a pair of turbines mounted on opposite sides of the flow channel outlet at a downstream side thereof and each turbine being oriented such that a portion of each is in the projected fluid flow path so that both turbines are simultaneously rotated in opposite directions and generally transverse to the projected fluid.

8. The rotary sprinkler of claim 7, wherein each of the pair of turbines includes a drive shaft extending along a drive axis where each drive axis is inclined toward each other and inclined relative to a flow axis extending generally coaxially from the flow channel outlet.

9. The rotary sprinkler of claim 8, wherein each of the drive axes are inclined relative to the flow axis from about 1° to about 10°.

10. The rotary sprinkler of claim 7, including a switching assembly that selectively couples one of the pair of turbines to the gearing assembly so that with the one turbine coupled to the gearing assembly the turret rotates in one direction and with the other turbine coupled to the gearing assembly the turret rotates in an opposite direction.

11. The rotary sprinkler of claim 1, wherein the flow channel includes a separate nozzle insert configured to be received in the flow channel, and the main drive element is configured to be shifted to allow the separate nozzle insert to be installed in the flow channel.

12. The rotary sprinkler of claim 1, wherein the main drive element includes a turbine with a drive shaft extending along a drive axis generally transverse to the projected fluid so that the turbine turns generally in the direction of the projected fluid.

13. The rotary sprinkler of claim 12, wherein a nozzle is oriented to project the fluid along the longitudinal axis of the stationary sprinkler body and the flow channel in the rotary turret includes a deflector portion thereof to redirect the fluid outwardly from the turret to irrigate the surrounding ground surface area.

14. A rotary sprinkler comprising:
a non-rotational body having a longitudinal axis therethrough;
a turret rotatably mounted to an end of the body;
a nozzle at the turret for discharging fluid to irrigate a surrounding area;
first and second drive turbines at the turret downstream of the nozzle, the first drive turbine having a first drive shaft configured to rotate the turret relative to the body in one direction and the second drive turbine having a second drive shaft configured to rotate the turret relative to the body in an opposite direction; and
at least one blade of each turbine extending in a path of fluid discharged from the nozzle so that each of the turbines is rotated at the same time but in opposite directions.

15. The rotary sprinkler of claim 14, wherein the first and second drive turbines are positioned at opposite sides of the nozzle.

16. The rotary sprinkler of claim 14, further including a switching mechanism that selectively couples the first and second turbine drive shafts to the rotary turret so that when the first drive shaft is coupled the turret rotates in one direction and when the second drive shaft is coupled the turret rotates in an opposite direction.

17. The rotary sprinkler of claim 14, wherein the first and second drive shafts are shiftable to permit removal of the nozzle.

18. The rotary sprinkler of claim 14, wherein the rotary sprinkler includes a gearing assembly having a transfer gear operably coupled to the turbines where the transfer gear transfers rotary motion of the turbines to effect rotation of the turret, the transfer gear is oriented at an inclined angle relative to the longitudinal axis of the body.

19. A rotary sprinkler comprising:
a non-rotational body having a longitudinal axis therethrough;
a turret rotatably mounted to an end of the body;
a nozzle at the turret including at least first and second outlets for discharging at least first and second fluid streams to irrigate a surrounding area;
a first conduit in fluid communication with the first outlet, the first conduit defined in the nozzle and housing a turbine adjacent a downstream portion thereof, the turbine having a drive shaft thereof configured to rotate the turret relative to the body by fluid flowing through the first conduit; and
a second conduit in fluid communication with the second outlet, the second conduit bypassing fluid around the turbine and discharging the second fluid stream with a higher energy than the first fluid stream.
